(19) United States
(12) Patent Application Publication
(10) Pub. No.: US 2015/0117643 A1
(43) Pub. Date: Apr. 30, 2015

(54) SYSTEM AND METHOD FOR PERFORMING A SECURE CRYPTOGRAPHIC OPERATION ON A MOBILE DEVICE COMBINING DATA FROM MULTIPLE SENSORS

(71) Applicant: Apriva, LLC, Scottsdale, AZ (US)

(72) Inventors: Randolph A. Best, Phoenix, AZ (US); Michael S. Klingen, Paradise Valley, AZ (US); Robert C. Smith, Phoenix, AZ (US); Charles S. Grochowski, Cocoa Beach, FL (US)

(73) Assignee: Apriva, LLC, Scottsdale, AZ (US)

(21) Appl. No.: 14/069,142

(22) Filed: Oct. 31, 2013

Related U.S. Application Data
(63) Continuation of application No. 14/067,581, filed on Oct. 30, 2013.

(51) Int. Cl. H04L 9/08; H04L 9/30

(52) U.S. Cl. CPC H04L 9/0869; H04L 9/30; H04L 2209/24
USPC 380/46

(57) ABSTRACT

In a mobile communication device, multiple sets of sensor measurement data are obtained, each from a corresponding hardware sensor resident on the device. Insufficiently random data is filtered from each of the data sets to produce random data sets which are combined to produce entropy data which is stored in an entropy data cache. An entropy pool is monitored to determine a level of entropy data available and, based on the level determined, entropy data is provided from the entropy data cache to the entropy pool. Entropy data from the entropy pool is then applied to perform a cryptographic operation such as the generation of an encryption key for encrypting communications sent or received by the mobile communication device.

### RELATED APPLICATION

This application is a continuation of U.S. patent application Ser. No. 14/067,581 filed on Oct. 30, 2013 and entitled SYSTEM AND METHOD FOR PERFORMING A SECURE CRYPTOGRAPHIC OPERATION ON A MOBILE DEVICE which is hereby incorporated by reference in its entirety.

### FIELD OF INVENTION

The invention relates generally to mobile communication devices and, more particularly, to secure cryptographic operations performed on a mobile device.

### BACKGROUND

Data encryption has existed in some form for almost as long as communication between human beings has existed. As the communication method has changed over time, so too has the method of encryption. In its early form, written symbols were used in place of a known alphabet to make written documents readable only by those who had knowledge regarding the translation of the symbols. While this sufficed for that form of communication, it was no longer effective when communication methods advanced beyond hand written documents. Many cryptography techniques were developed as new communication methods came into use.

Today's communication is largely facilitated through electronic means. As such, widely used encryption models depend on private and public key encryption, both of which rely on the application of encryption keys to cryptographic algorithms. These encryption keys include private or secret keys which, if discovered or deduced by unintended parties, would allow for those parties to decrypt and discover the encrypted information. With increasingly sophisticated hackers and methods, deduction of private or secret keys becomes entirely possible if the keys are generated using non-random or predictable methods. For this reason, random data sources are now utilized in the process of generating encryption keys.

One method of generating secure encryption keys is facilitated though use of a naturally random data source to generate truly random numbers that are used with various encryption protocols to generate the keys. Another method utilizes mathematical algorithms such as pseudorandom number generators (PRNGs) to produce random numbers to be used to generate the encryption keys. Specifically, a PRNG is an algorithm for generating a sequence of numbers that approximates the properties of random numbers. However, the sequence is not truly random in that it is completely determined by a relatively small set of initial values, called the PRNG's state.

While truly random numbers are ideal for generating encryption keys, they are not always practical. Therefore, many encryption systems use a PRNG to generate encryption keys. Because the streams of numbers generated by a PRNG are not truly random, however, they are susceptible to cryptanalysis. Furthermore, if the PRNG algorithm is or becomes known, the security of any encryption keys based on the generated stream of numbers depends largely upon the security of the initial state of the PRNG. This is typically determined by the seed value, or seed, which is a number that is used to initialize the PRNG process. The seed defines the starting point within the stream of numbers, so knowledge of the PRNG and discovery of the seed value would allow an attacker to predict the portion of the generated stream of numbers used to generate a particular encryption key.

It is therefore desirable to generate random values with a high degree of unpredictability, or entropy, for use as seed values as described above and any other aspects of cryptographic operations where unpredictably random values are beneficial or essential. Furthermore, as security of communications can be essential in a mobile environment, it is especially desirable to provide strong entropy within the challenging confines and constrictions of a mobile communications device. It is further desirable to generate random values with strong entropy that will be readily and quickly available as needed to perform cryptographic operations on the mobile communications device. It would also be desirable to do so in a way, where possible and appropriate, that is transparent in that no special actions are required of the user of the mobile communications device. It would further be desirable to provide a user of the mobile communications device with an ability to determine the entropy strength available at a given moment.

### SUMMARY OF THE INVENTION

In general, the invention overcomes the limitations of the prior art by utilizing common hardware components of a mobile communication device to generate strong entropy data for use in cryptographic operations. For example, the invention facilitates secure wireless communications in a mobile communication device having one or more hardware sensors for measuring environmental variables, in which sensor data from the hardware sensors is used to generate highly random data to be applied in the encryption of communications performed over the mobile communication device.

In one possible embodiment of the invention, measurement values output by one or more sensors are utilized for seeding a PRNG that generates a stream of numbers which are suitable for use in encryption key generation. The encryption key is exchanged between the intended communications parties, at which point encrypted messages can be sent back and forth between the parties.

In one version of this embodiment and appropriate alternatives, the measurement values from one or more sensors can be used directly for real time encryption key generation. In other words, the values from the sensors are retrieved only when encryption is needed. This approach may reduce battery use in that it only reads from the targeted sensors as needed.

In another version, values from the sensors can be cached during the normal operation of the sensors. The cache may be used to refill an entropy pool, such that the pool of values is only refilled when it is reduced to a defined level as values are being used to seed the PRNG. This approach may avoid delay in the encryption process.

In an embodiment of the invention, multiple sets of sensor measurement data may each be obtained from a corresponding one of multiple hardware sensors resident on the mobile communication device. Filters may also be provided which filter insufficiently random data from each of the multiple sets of sensor measurement data to provide a corresponding one of multiple sets of random source data. The multiple sets of random source data are combined to produce entropy data, which is stored within a cache.

An entropy pool maintains a defined quantity of entropy to be used as needed for cryptographic operations. The entropy pool is monitored to ensure that a predefined amount of entropy data remains in the pooled values. If the volume of entropy values in the entropy pool falls below the defined level, then entropy values are moved from the cache to the entropy pool. When there is a need to perform a cryptographic operation, entropy values are retrieved from the entropy pool.

When additional or more strongly random entropy data is needed, the user of the mobile communication device may be prompted to take an action which increases the amount of random data obtained by the hardware sensors, such as by shaking the device to increase inertial measurement data.

A display icon may also be included on the mobile communication device to make the user of the device aware of the general level of encryption. Based on the strength of the entropy, which can be determined in a number of manners, the icon can show the general encryption strength graphically, such that the user can adjust the types of information exchanged based on their level of assurance in the encryption level.

### BRIEF DESCRIPTION OF EXEMPLARY DRAWINGS

A more complete understanding of the present invention may be derived by referring to the detailed description and claims when considered in connection with the Figures, wherein like reference numbers refer to similar elements throughout the Figures, and:

FIG. 1 is a diagram showing physical components of a mobile communication device in accordance with one embodiment;

FIG. 2 is a block diagram showing functional components of the mobile device in accordance with one embodiment;

FIG. 3 is a flowchart showing steps for performing a secure cryptographic operation by way of entropy data derived from data from one or more hardware sensors in accordance with one embodiment; and

FIG. 4 is a flowchart showing steps for generating, supplementing and/or increasing the strength of entropy data based on user action affecting sensor readings in accordance with one embodiment.

### DETAILED DESCRIPTION OF EXEMPLARY EMBODIMENTS

The present invention facilitates highly secure communications between mobile devices through generation of unpredictably random values for use in cryptographic operations. In one application, the system and method uses sensor readings from one or more onboard sensors to provide a seed value for a pseudorandom number generator.

The disclosed method and system uniquely applies data from sensors that are included within most conventional smartphones. The sensor data, particularly when provided with filtering and combined with sensor data from other sensors, facilitates strong entropy and is therefore well suited for seeding a PRNG to generate numeric values that are suitable for use in encryption key generation. These values are cached and stored in an entropy pool. The values in the entropy pool are used as needed to generate encryption keys. The entropy pool is monitored and additional sensor data is processed to create additional entropy data as needed to maintain a sufficient quantity of entropy data in the entropy pool. This ensures that sufficient entropy data remains available in situations where insufficiently strong entropy values can be immediately obtained from the one or more sensors, while also avoiding unnecessary processing of sensor data in excess of what will be needed to produce sufficient entropy data.

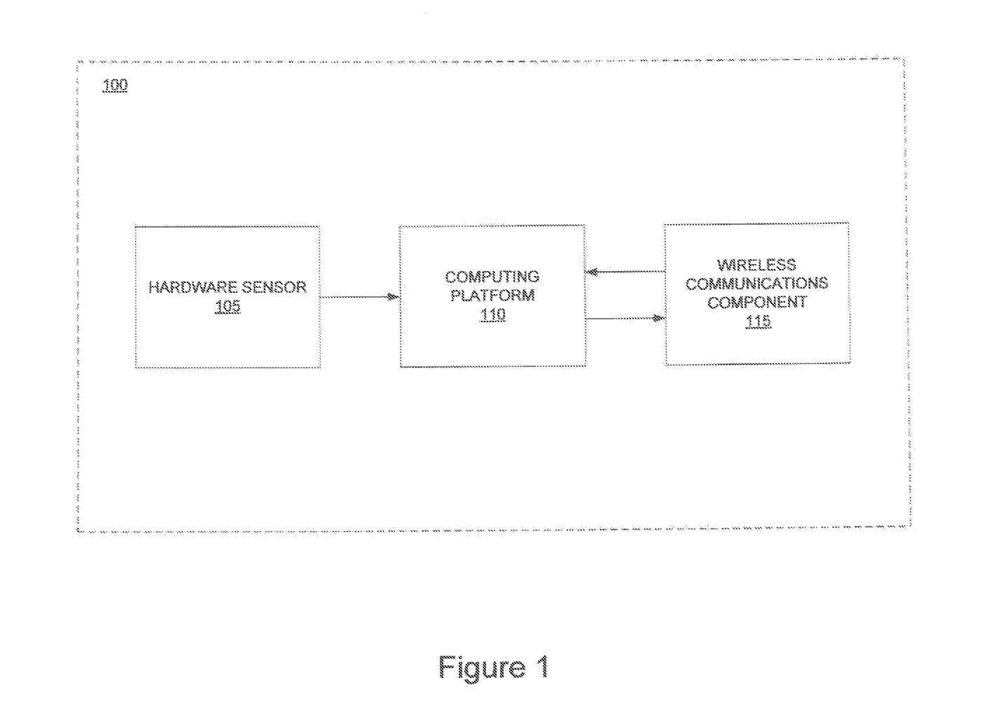

FIG. 1 is a block diagram showing physical components of a mobile communication device in accordance with one embodiment. Mobile device 100 comprises a hardware sensor 105, a computing platform 110, and a wireless communication component 115. Hardware sensor 105 communicates with computing platform 110 such that appropriate requests and controls can be sent from computing platform 110 to hardware sensor 105 and sensor data can be sent from hardware sensor 105 to computing platform 110. Computing platform 110 communicates with wireless communication component 115 such that instructions and controls can be provided and appropriate data can be obtained in the performance of wireless communications. Sensor measurement data is retrieved from hardware sensor 105 and processed, as will be explained in greater detail below, by computing platform 110 to provide strong entropy data to facilitate a secure cryptographic operation, such as securely encrypted communication via the wireless communication component 115.

In an embodiment of the invention, a plurality of hardware sensors 105 is utilized. While the term “sensor” is used herein in reference to a hardware device that measures the state of something (e.g., inertia, location, position, temperature, etc), those of ordinary skill in the art will appreciate that a number of hardware sensors presently exist within commercially available smartphones and other remote communication devices. Such sensors are used to obtain and provide location information, determine the orientation of the device, determine and adjust the brightness of a screen, determine and adjust sound recording levels, obtain and interpret tactile input by the user, identify and remove noise from camera and video images, and so forth. Therefore, hardware sensor 105 may comprise any of a number of different types of sensors such as, for example, an accelerometer, gyroscope, electronic compass, Global Positioning System (GPS) receiver, barometer, thermometer, proximity sensor, ambient light sensor, audio sensor, and so forth. Selection of such sensors will be based on the ability of such sensors at the time to produce data that is unpredictably random enough to provide levels of entropy sufficient for the needs of the application at hand.

As one example, hardware sensor 105 comprises an inertial measurement sensor such as a sensor that may be part of an Inertial Measurement Unit (IMU). An IMU measures changes in its own trajectory by measuring its own linear acceleration, or its own angular rate, or some combination of its linear acceleration and angular rate. Typically, this is also the change in trajectory of something the inertial measurement sensor is physically attached to, such as mobile communication device 100. Commonly, an IMU measures linear acceleration with up to three linear accelerometers. Angular rate is typically measured with up to three gyroscopes. At least one magnetometer (electronic compass) may also be utilized. Typically, the IMU measures its linear acceleration and angular rate in at least one dimension and in up to as many as six degrees of freedom. Each sensor (accelerometer, gyroscope, etc.) forms new measurement values for each degree of freedom at a predetermined frequency and each may serve as a uniquely different one of multiple hardware sensors 105.

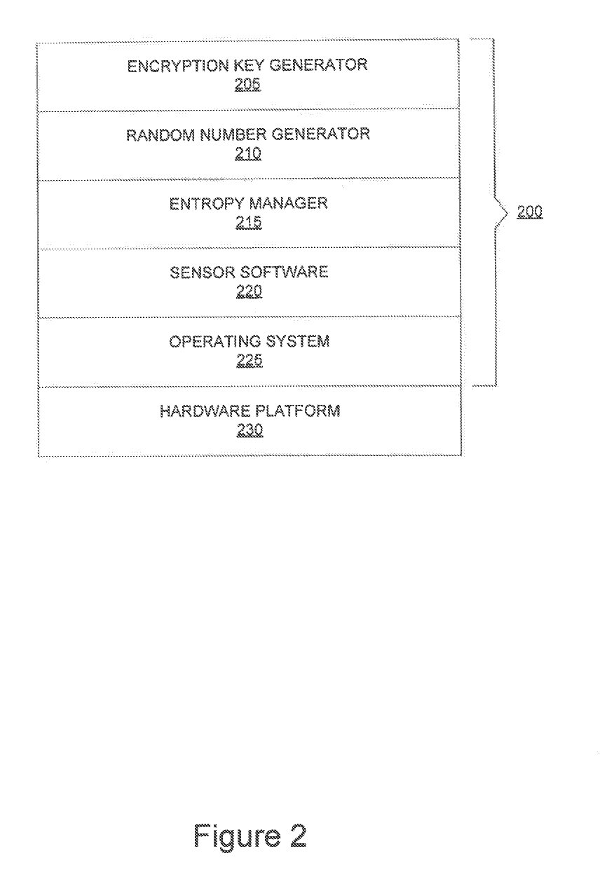

FIG. 2 is a block diagram showing functional components of the mobile device relevant to functions performed in accordance with one embodiment of the invention. Hardware platform 230 comprises a memory 200 for maintaining the operating system 225, sensor software 220, an entropy manager 215, random number generator 210, and encryption key generator 205. Those of ordinary skill in the art will appreciate that the features discussed with respect to any one of the components may reside with any other component as may be appropriate for desired applications of the invention.

The hardware platform 230 may comprise a smartphone or smartwatch, a tablet, netbook or notebook computer provided with communications capability, or any other appropriate mobile communications device.

Memory 200 is sufficiently large to store the above functional components as well as the sensor measurement values received from one or more of hardware sensor 105, communications received from wireless communication device 115, and so forth. Memory 200 further comprises, either separately or as an element of the functional components described above, one or more sensor data caches, each corresponding to a hardware sensor 105. Memory 200 further comprises an entropy data cache and an entropy pool, as will be described in more detail below. Memory 200 may be implemented with one or a number of like or unlike physical memory components and may be composed of nonvolatile memory, volatile memory, or a combination thereof.

The operating system 225 may comprise any known system software for managing the disclosed mobile communications device or any other device that may incorporate the disclosed random number based encryption system. Known operating systems 225 include, for example, Android OS by Google, Inc.; iOS from Apple, Inc.; and Windows Mobile by Microsoft, Inc.

Sensor software 220 includes drivers for facilitating communication between the operating system 225 and the hardware sensor 105. Sensor software 220 may further include instructions specific to the sensor in order to invoke the sensor, process input, and format values. In one embodiment, the sensor software 220 is incorporated within the operating system 225.

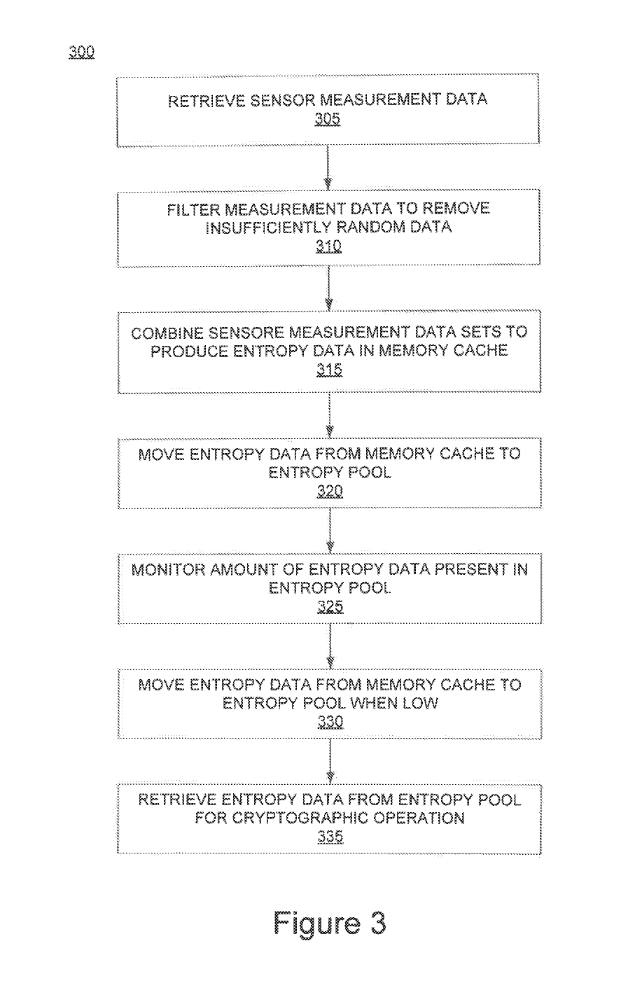

Entropy manager 215 performs functions to retrieve sensor measurement data from hardware sensors 105, as well as to filter, cache and combine the data to produce strong entropy data, cache the strong entropy data, monitor the entropy pool and provide strong entropy data to the entropy pool as needed. This will be explained in more detail with reference to FIG. 3 below.

Encryption key generator 205 and random number generator 210 may, in the aggregate, include any cryptographic protocol, or any combination of cryptographic protocols, the overall security of which depends, at least in part, on random numbers for encryption key generation. Encryption key generator 205 and random number generator 210 may comprise a proprietary combination of encryption primitives such as hash functions, elliptic curve math functions, big number math functions, digital signature schemes, block ciphers, PRNGs, key agreement schemes, message authentication codes, and the like.

Those of ordinary skill in the art will appreciate that selection and configuration of the above components is to some extent a design choice influenced by a variety of factors including the level of security desired, the amount of processing power available in hardware platform 230, the amount and configuration of memory 200, acceptable time delay caused by encrypting and decrypting messages, and so forth.

FIG. 3 is a flowchart showing steps for performing a secure cryptographic operation by way of entropy data generated from one or more hardware sensors in accordance with an embodiment of the invention. These steps are performed, for example, by the entropy manager 215 in control of or in conjunction with operating system 225, sensor software 220, random number generator 210 and encryption key generator 205. In various embodiments, the disclosed system may perform readings from one or multiple similar or disparate sensors of same or different types such as those described above. As such, potential sources for entropy data are extensive and data from any number of sensors may be combined to create strong entropy. Data from multiple sensors may be segregated or combined in any manner as is desirable so as to be used in accordance with the invention to provide strong entropy data allowing for highly secure cryptographic operations on the mobile communications device.

At any predefined or event driven interval or point in time, one or more sets of sensor measurement data are obtained (Step 305). Each set of sensor measurement data may be retrieved from a corresponding one of multiple hardware sensors 105 that are resident on the mobile communication device 100. In other words, entropy data is retrieved from each sensor either consecutively or simultaneously such that the system ultimately has a data set representing data from each of any number of resident sensors.

Each of the data sets is filtered to remove insufficiently random data so as to provide a corresponding one of multiple sets of random source data (Step 310). In an embodiment of the invention, the entropy strength of each data set is measured and compared to a minimum entropy strength threshold value. One of ordinary skill in the art will recognize available techniques for measuring entropy strength and will select, adapt or otherwise create means for measuring entropy strength that are appropriate for the application at hand.

In one version of this embodiment, the threshold value is predefined. The predefined threshold value may be the same or different for different data sets. In another version, the threshold value may correspond to or be at least partially based on measured entropy levels of one or more other data sets from other sensors. In such case, one or more of the data sets may be selected or rejected based on their entropy level as compared to that of other data sets. For example, a data set may be selected only if it has a determined entropy strength that surpasses an entropy strength of a different data set.

In yet another embodiment, multiple threshold values may be defined which correspond to contextual variables. For example, a minimal threshold value may be higher for a communications session wherein one or more participants are physically located in a certain geographical region (e.g., France, United States, Egypt, Russia, Thailand, etc.). Other examples of contextual variables include the identity of the call participants, military rank, date, time of day, current events indicative of increased security risk such as internal political disputes or large scale protests, and so forth.

Filtering may further include, such as prior to comparison to the one or more threshold values, performance of basic tests to ensure the source data is continually changing, including the maintaining of and comparison to previous source values, the elimination of duplicate data, and the removal of higher order bits of source data that are not random. Removal of insufficiently random data strengthens the entropy of the data and may also reduce the processing load and/or free up memory to ensure that the disclosed entropy data collection and information encryption minimally impacts overall processing speed and battery power consumption.

The user of the mobile communication device may also be notified of the entropy strength of the source data and/or whenever one or more threshold values are not met. This may be indicated, for example, by an icon displayed on a graphical user interface of the mobile communication device 100. Practitioners will appreciate that the steps relating to when data is filtered, where it is stored, and other such details are presented herein for explanation of one exemplary embodiment. Reordering steps or defining different memory locations, unless such reordering and/or defining would render the invention inoperable as disclosed herein, does not depart from the scope of the invention.

The filtered data sets are combined to produce aggregate data, hereinafter referred to as entropy data, which is unpredictably random enough to support cryptographic operations that are sufficiently secure for the applications to which they are applied (Step 315). Prior to combination, each data set may be cached independently in a corresponding sensor data cache to allow for immediate retrieval. The data sets may be combined, for example, by applying an XOR function or by applying a hash operation. Strong entropy may further be facilitated by weighting the data differently from each of the data sets. Strong entropy may also be facilitated by combining different data sets from different types of sensors. For example, data from an inertial measurement sensor such as an accelerometer or gyroscope may be combined with data from an ambient light sensor. After combination, the entropy data may be stored in an entropy data cache to allow data to be immediately available for cryptographic operations or further processing without waiting to retrieve and process additional sensor data. The entropy data cache may be implemented in volatile memory to provide security and/or other advantages.

In one embodiment, the entropy data may be immediately retrieved from the entropy data cache to be applied to a cipher algorithm for encrypting information that is to be transmitted over a network to a receiving device. In another embodiment, entropy data is moved from the entropy data cache to an “entropy pool” (Step 320) such that it is immediately and readily available for use in performing cryptographic operations, while also freeing at least a portion of the entropy data cache to continue collecting data. The entropy pool may comprise an area of memory, such as a specific portion of the operating system, which has been predefined for the provision of random data. In a Linux-based system such as Android, for example, the entropy pool may be implemented with the /dev/random module.

To ensure that a sufficient amount of entropy data is readily available, the entropy pool is persistently or periodically monitored (Step 325). A minimum level of entropy data to be stored in the entropy pool is predefined in order to ensure that sufficient entropy data is available for real-time cryptographic operations such as information encryption so as to avoid communication delays due to collecting sufficiently strong entropy in real-time. Also, having a defined minimum level of stored entropy data may reduce or eliminate unnecessary consumption of system resources for collecting, processing, and storing entropy data beyond that which will be consumed during a communication session. When the entropy pool drops below the defined minimum level of entropy data, then entropy data is retrieved from the entropy data cache and added to the entropy pool (Step 330).

Entropy data may thereafter be retrieved from the entropy pool and used to perform a cryptographic operation (Step 335). Such a cryptographic operation may facilitate encryption of a data transmission which may include, for example, voice or text data resulting from a phone call, SMS, email message, and the like. A number of encryption methodologies are known and vary in sophistication and security. Those of ordinary skill in the art will appreciate that the disclosed system may incorporate any one or more known encryption techniques, may incorporate a proprietary methodology, or incorporate any combination thereof.

In one embodiment, use of entropy data from the entropy pool comprises providing the entropy data to seed a pseudorandom number generator (PRNG). Most commercially available smartphones include a PRNG, which generates sufficiently random data to provide a degree of privacy for standard data transmission operations through arithmetical methods of producing random digits, which are used to create a cipher. Those of ordinary skill in the art will appreciate that a PRNG, when used in combination with the disclosed entropy data, can generate random values having sufficiently strong entropy to facilitate highly secure data encryption, such as encryption meeting standards that are required by governmental entities, on a commercially available mobile communication device. Moreover, by augmenting an existing encryption infrastructure and workflow with the disclosed system and methodology, data security for a commercially available mobile communication device can be significantly improved at minimal expense and without risking conflicts between the device hardware and existing communication protocols and applications.

By seeding the PRNG with a value derived from strong entropy data, the output of the PRNG provides for highly secure encryption. In alternative embodiments for various purposes, rather than serving as a seed value for a PRNG to output an encryption variable, the entropy data may be used in other ways that may prove beneficial to produce highly secure encryption capability. For example, entropy data provided by the disclosed system and method may be directly provided as random data to a cryptographic module resident on the communication device.

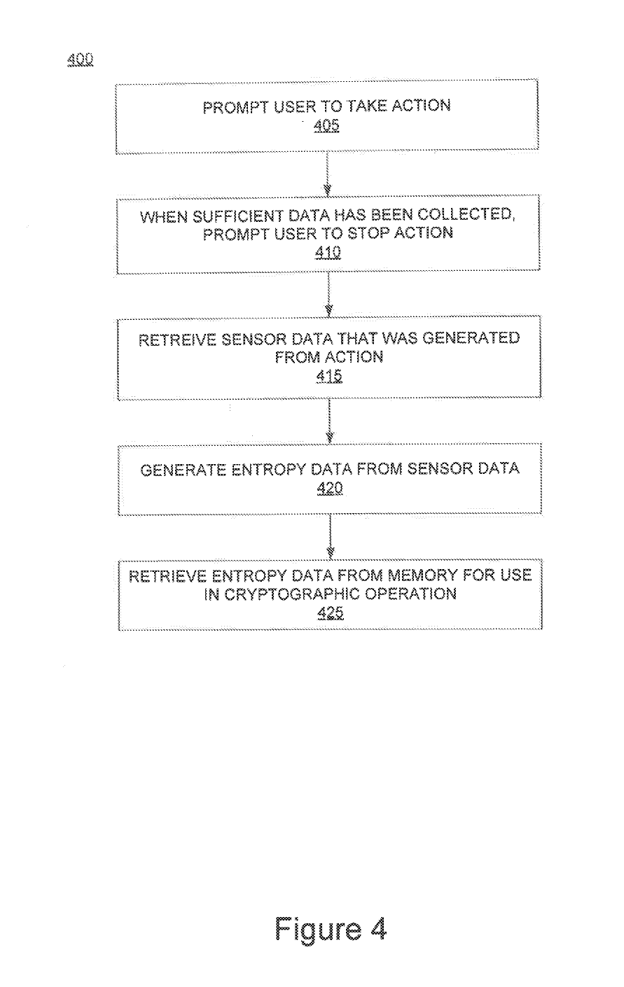

In an embodiment of the invention, the disclosed system may require an action from the user of the mobile communications device 100 in order to collect, supplement and/or strengthen the entropy data. FIG. 4 is a flowchart showing steps for generating entropy values based on user action affecting sensor readings. In situations where adequately strong entropy cannot be collected or when a situation requires a specific type of entropy, the key generation process may require human intervention and prompt the user to perform an action (Step 405). Where sensor measurement data as described above includes inertial measurement data from inertial measurement sensors such as accelerometers, gyroscopes and magnetometers, for example, this may include prompting the user to subject the device to a physical motion in order to invoke readings from specific sensors.

For example, if a high threshold for entropy strength is defined due to the nature of the communication, the data generated by one or more sensors may not meet the required strength. In such case, the mobile communication device 100 may prompt the user to shake the device for a given duration. The shaking motion increases the amount and/or variation of data generated by the inertial measurement sensors. In one embodiment, the system may determine whether the entropy resulting from the directed motion is sufficient. If it is not sufficient, the user may be prompted to repeat the action or perform a different action. In another embodiment, the user may be directed to shake the device for an initially unspecified duration. While the device is in motion, the system determines in real time the accumulated entropy strength. When the entropy strength threshold has been met, the user is alerted to stop the action (Step 410).

When adequate entropy has been collected, the system obtains specific sensor measurement data (Step 415) from a hardware sensor 105 such as in a manner similar to that described with respect to Step 305 above. The system generates entropy data based on the sensor measurement data (Step 420) such as in a manner similar to that described with respect to Steps 310-330 above. In one embodiment, the sensor data is simply cached or stored in its original format, which is consistent with the format of the entropy data. In another embodiment, the sensor data is converted by way of an algorithm or equation to a specific format that is consistent with an entropy value. When needed, the entropy value is retrieved from memory and applied to performing a cryptographic operation such as in a manner similar to step 335 as described above (Step 425).

Those of ordinary skill in the art will appreciate that the strength, amount, and type of sensor data needed to generate entropy of adequate strength may vary in accordance with the type of sensor that is generating the data, the number of sensors employed in order to combine sensor data, the level of encryption required, the type of device being used, and the network that will serve as the conduit for transferring encrypted data. As such, the process used to generate entropy may be dynamic. For example, the amount of entropy required for a communication being sent to Recipient A may be more than the amount of entropy required to send the same communication to Recipient B. As such, it is contemplated that the system includes the ability and employs the resources required to make such determinations that will affect the entropy requirements.

It will also be appreciated that for different types of sensors, different user actions would be performed. Whereas random data from an inertial data sensor may be stimulated by imparting motion to the phone, random data from an ambient light sensor may be stimulated by holding the phone up within and/or directed towards variously lit areas. One of ordinary skill will understand appropriate actions that will increase the amount and/or variation of data from various types of sensors. Furthermore, where data from different types of sensors are combined in the generation of entropy data, such as where data from an inertial measurement sensor is combined with data from an ambient light sensor, multiple user actions may be performed.

The present invention may be described herein in terms of functional block components, optional selections and/or various processing steps. It should be appreciated that such functional blocks may be realized by any number of hardware and/or software components suitably configured to perform the specified functions. For example, the present invention may employ various integrated circuit components, e.g., memory elements, processing elements, logic elements, look-up tables, and/or the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), Microsoft.Net with the various algorithms being implemented with any combination of data structures, objects, processes, routines or other programming elements. Further, it should be noted that the present invention may employ any number of conventional techniques for data transmission, messaging, data processing, network control, and/or the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by Mayiam Stalling, published by Prentice Hall; all of which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. It should be noted that many alternative or additional functional relationships or physical connections might be present in a practical transaction card distribution system.

One skilled in the art will appreciate that a network may include any system for exchanging data or transacting business, such as the Internet, an intranet, an extranet, WAN, LAN, satellite communications, cellular network, and/or the like. Moreover, although the invention is frequently described herein as being implemented with specific communications protocols, it may be readily understood that the invention could also be implemented using HTTP, TCP/IP, SMTP, Bluetooth, IPX, AppleTalk, IP-6, NetBIOS, OSI or any number of existing or future protocols. Moreover, the system may contemplate the use, sale or distribution of any goods, services or information over any network having similar functionality described herein.

As may be appreciated by one of ordinary skill in the art, the present invention may be embodied as a method, a device, and/or a computer program product. Accordingly, the present invention may take the form of any appropriate combination of software and hardware or other physical devices. Furthermore, the present invention may take the form of a computer program product on a tangible computer-readable storage medium having computer-readable program code means embodied in the storage medium. Any suitable tangible computer-readable storage medium may be utilized, including hard disks, CD-ROM, optical storage devices, magnetic storage devices, and/or the like.

These computer program instructions may also be stored in a computer-readable memory that may direct a computer or other programmable data processing apparatus to function in a particular manner, such that the instructions stored in the computer-readable memory produce an article of manufacture including instruction means which implement functions of flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus include steps for implementing the functions specified in the flowchart block or blocks.

In the foregoing specification, the invention has been described with reference to specific embodiments. However, it may be appreciated that various modifications and changes may be made without departing from the scope of the present invention. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

1. A method of performing a secure cryptographic operation, the method performed by a mobile communication device and comprising the steps of:
obtaining multiple sets of sensor measurement data, each being obtained from a corresponding one of multiple hardware sensors resident on the mobile communication device, the multiple hardware sensors each comprising one of an inertial data sensor, an ambient light sensor, a proximity sensor, a global positioning system, a touch screen, a camera and a microphone;
combining the multiple sets of sensor measurement data to produce entropy data; and
applying the entropy data to perform a cryptographic operation.

2. The method of claim 1 wherein the step of combining the multiple sets of sensor measurement data comprises applying an XOR function to the sensor measurement data to produce the entropy data.

3. The method of claim 1 wherein the step of combining the multiple sets of sensor measurement data comprises applying a hash operation to the sensor measurement data to produce the entropy data.

4. The method of claim 1 wherein the step of obtaining multiple sets of sensor measurement data comprises
obtaining a first set of sensor measurement data from a first hardware sensor that is one of an inertial data sensor, an ambient light sensor, a proximity sensor, a global positioning system, a touch screen, a camera and a microphone, and
obtaining a second set of sensor measurement data from a second hardware sensor that is a different one of an inertial data sensor, an ambient light sensor, a proximity sensor, a global positioning system, a touch screen, a camera and a microphone, than the first hardware sensor.

5. The method of claim 1 wherein the step of obtaining multiple sets of sensor measurement data comprises obtaining at least one set of sensor data from by an inertial measurement sensor.

6. The method of claim 1 wherein the step of obtaining multiple sets of sensor measurement data comprises obtaining a first set of sensor data from an inertial measurement sensor and a second set of sensor measurement data from an ambient light sensor.

7. The method of claim 1, further comprising the step of removing, prior to the step of combining the multiple sets of sensor measurement data, duplicate data from one or more of the multiple sets of sensor measurement data.

8. The method of claim 1 wherein the step of applying the entropy data comprises providing the entropy data to seed a pseudorandom number generator.

9. The method of claim 1 wherein the step of applying the entropy data comprises providing the entropy data to a cryptographic module.

10. The method of claim 1 wherein the step of applying the entropy data to perform a cryptographic operation comprises applying the entropy data to encrypt data communicated over the mobile communication device.

11. A mobile communication device comprising:
multiple hardware sensors, each generating one of correspondingly multiple sets of sensor measurement data, the multiple hardware sensors each comprising one of an inertial data sensor, an ambient light sensor, a proximity sensor, a global positioning system, a touch screen, a camera and a microphone;
an entropy management module combining the multiple sets of sensor measurement data to produce entropy data; and
means for applying the entropy data to perform a cryptographic operation.

12. The mobile communication device of claim 11 wherein the entropy management module combines the multiple sets of sensor measurement data by applying an XOR function to the multiple sets of sensor measurement data.

13. The mobile communication device of claim 11 wherein the entropy management module combines the multiple sets of sensor measurement data by applying a hash operation to the multiple sets of sensor measurement data.

14. The mobile communication device of claim 11 wherein the multiple hardware sensors comprise
a first hardware sensor that is one of an inertial data sensor, an ambient light sensor, a proximity sensor, a global positioning system, a touch screen, a camera and a microphone, and
a second hardware sensor that is a different one of an inertial data sensor, an ambient light sensor, a proximity sensor, a global positioning system, a touch screen, a camera and a microphone, than the first hardware sensor.

15. The mobile communication device of claim 14 wherein at least one of the multiple hardware sensors is an inertial measurement sensor.

16. The mobile communication device of claim 14 wherein the first hardware sensor is an inertial measurement sensor and the second hardware sensor is an ambient light sensor.

17. The mobile communication device of claim 11, further comprising means for removing, prior to combining the multiple sets of sensor measurement data, duplicate data from one or more of the multiple sets of sensor measurement data.

18. The mobile communication device of claim 11, further comprising a pseudorandom number generator, and wherein the entropy data stored in the entropy pool is applied to seed the pseudorandom number generator.

19. The mobile communication device of claim 11, further comprising a cryptographic module, and wherein the entropy data stored in the entropy pool is applied to the cryptographic module.

20. The mobile communication device of claim 11, further comprising means for applying the entropy data stored in the entropy pool to encrypt data communicated over the mobile communication device.
